(19) United States
(12) Patent Application Publication
(10) Pub. No.: US 2006/0055672 A1
(43) Pub. Date: Mar. 16, 2006

(54) Input control for apparatuses

(76) Inventors: Martin Krocker, Dresden (DE); Harald Schenk, Dresden (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/225,561

(22) Filed: Sep. 13, 2005

(30) Foreign Application Priority Data
Sep. 16, 2004 (DE) 10 2004 044 999.6

(51) Int. Cl. G09G 5/08

(52) U.S. Cl. 345/158

(57) ABSTRACT

A device for controlling an apparatus depending on a position or movement of an object in a control region includes a light-beam mover for moving a light-beam in the control region depending on a light-beam motion signal to guide the light-beam over the control region, different positions or positional changes of the object or several objects in the control region being associated to different reactions in the apparatus, a light sensor for detecting a reflected light-beam to generate a sensor output signal depending on the reflected light-beam, and a control signal generator which is formed to generate, depending on the light-beam motion signal and the sensor output signal a control signal for the apparatus which is formed to cause a reaction in the apparatus associated to a position or positional change in the control region defined by the light-beam motion signal and the sensor output signal.

### BACKGROUND OF THE INVENTION

### CROSS-REFERENCE TO RELATED APPLICATION

This application claims priority from German Patent Application No. 10 2004 044 999.6, which was filed on Sep. 16, 2004, and is incorporated herein by reference in its entirety.

1. Field of the Invention

The present invention relates to a device for controlling an apparatus depending on a position or movement of an object in a control region, and to a method for controlling an apparatus depending on a position or movement of an object in a control region.

2. Description of Related Art

The improvement of communication between humans and machines and the quest for new input techniques is gaining in importance due to ever more complex computer applications. For this reason, it is a goal of many technological developments to develop, apart from the classic input devices of a computer, such as, for example, keyboard, graphics tablet, mouse, etc., and input methods being developed, such as, for example, voice and handwriting recognition, new ways of interaction with machines adjusted to natural spatial human communication. Gestures and facial play of humans naturally are suitable for this since these ways of expressing oneself are of high importance in the natural communication between humans. In order to make these ways of expressing of humans usable as an input method for computers, head and body movements must be recognized and interpreted.

Nearly all modern electrical apparatuses with and without graphical user interfaces comprise input devices for operation, such as, for example, keyboards, mice or keys or switches directly on the device. They serve for indicating and selecting texts, images or even spaces in virtual realities, for inputting in character strings or for switching on and off an apparatus. All these devices are expected to be of high reliability, robustness, easy operability and precision. All these devices, however, are subject to high wear and, in particular in operating elements used outside, high pollution. Another disadvantage of well-known solutions is the usually indirect conversion of finger or hand movements, such as, for example, by pressing a mechanical switching element or moving a mouse, into electrical signals. Furthermore, gaps and other misshapen surfaces of such apparatuses make cleaning and ensuring sterility more difficult. Additionally, keyboards still require a relatively large amount of space and mice require a smooth surface or a surface rich in contrast. Another disadvantage is that input devices often maximally operate in two dimensions and limit the user in his/her natural movements and are mostly implemented as external supplemental devices. Furthermore, virtual control devices interpreting the ways of expression of human gestures and converting them into commands for controlling data processing systems have been known.

Computer mice are mainly electrical devices detecting their own movements caused by the operator's hand and converting them to an electrical signal representing the current coordinates of the mouse. The main part of the mouse is a ball driven over the mouse operating area at the bottom of the mouse casing. Inside the casing, this movably held ball transfers the movement of the mouse to pressure rolls. These roller-like rolls are arranged in an angle of 90°. Depending on the angle of movement, either only one roller moves or both rollers move. Thus, it can be recognized in which direction the mouse has been moved. Plastic wheels into which a wire is embedded in an arm-like configuration, are arranged at the ends of the rollers. These wheels rotate, together with the roller, about their own axis. Thus, the rotational movement is converted into electrical impulses. The conversion of the movement into electrical impulses is realized either mechanically via contact pins or opto-electronically via light barriers. In a PC, the electrical impulses received via the mouse cable are converted into x and y coordinates for the mouse indicator on the monitor. Two, maybe three mouse keys are placed at the back part of the mouse where they can be reached easily for the fingers of the hand. When the mouse indicator is positioned correspondingly, program steps are triggered via these by clicking. Right and left mouse keys are employed for different things.

Modern mice differ with regard to the detection of movement in that they are realized by means of optical components. The optical scanning system detects movements in two mutually perpendicular coordinate directions. Often, there are one or several electrical tracers on the casing of the mouse for inputting commands usually serving to trigger functions which are connected to the position or the path of the cursor on the monitor. The mechanical components subject to wear, the gaps and thus pollution and, in the end, the guarantee of functioning are disadvantages of these solutions. Additionally, such a method is limited to a two-dimensional area of movement.

Another input device is the keyboard. Keyboards and control panels known today usually include mechanical switching elements opening and closing, respectively, an electrical contact by a pressure caused by a finger. The mechanical components which are moved and are subject to high wear are of disadvantage here. Keyboards and control panels of this kind have gaps which make cleaning more difficult and allow dirt particles to penetrate. There are also membrane keypads ensuring a sealed surface which are, however, mechanically sensitive due to the material used and limit operational convenience.

DE 10211307 shows key elements radiating light through a light guide and coupling in reflected scattered light via the same light guide and passing it on to a receiving element.

U.S. Pat. No. 4,092,640 teaches a switching element making use of the antenna effect of the human body and thus triggering a switching process by a suitable electronic conversion.

Additionally, devices uniting display and input devices in one device are also known. So-called touch screen systems are known as graphical user interfaces. A touch screen is a touch-sensitive display by means of which switching processes can be triggered by pressing one's fingers or, particularly in small designs, by pressing a pin-like element. Disadvantages of this technology are mechanical wear of the touch screen surface and the high price and the low operational convenience in small designs. In particular for mobile phones, touch screens insensitive to impact having recognition electronics arranged behind a display of the touch screen for recognizing characters input or selected menu items are known, which, however, require a pencil for input which is provided with passive electronic components adjusted to the touch screen. The fact that the user has to rely on the small pencil for input is of disadvantage here as well as the fact that the system is no longer functional when the pencil gets lost.

Another way of implementing input devices are virtual keyboards. In the journal “Elektronik” (No. 9/2004), for example, the U.S. company VKB present virtual keyboards which can project a keyboard to any surface by means of a red laser diode and corresponding optics. The detection whether a key has been pressed takes place via an additional infrared laser diode, a chip set and an infrared camera. Infrared laser light emitted in the direction of the keyboard is reflected by the finger of the operator and evaluated by means of the camera and the chip set.

Virtual keyboards made by the iBIZ Technology company, which have also been introduced in the journal “Elektronik” (No. 9/2004), also operate according to the principle of projection by means of a red laser diode and detection by means of an infrared laser diode and a camera.

DE 4201934 teaches data processing systems which may be controlled by ways of expression of human gestures. In these systems, the detection of movements of the human body or parts thereof takes place by recording pictures by means of a camera. When this system is to be coupled by means of a virtual graphical user interface, an addition projection unit is also required here.

All the virtual input devices known so far operate according to the principle of image processing systems, such as, for example, camera measuring technology or stereoscopy, i.e. by recording brightness information in areas by means of a camera and by evaluation thereof. When such systems are to be used for interpreting a three-dimensional user interface, a second camera is required (stereo method), which increases complexity, size and requirements of the evaluating electronics considerably. When the well-known solutions are to be coupled to a virtual graphical user interface, such as, for example, a keyboard or a mouse pad, an additional projection unit is necessary.

### SUMMARY OF THE INVENTION

It is an object of the present invention to provide a concept for controlling an apparatus, which may be implemented at low cost and in a simple way.

In accordance with a first aspect, the present invention provides a device for controlling an apparatus depending on a position or movement of an object in a control region, having: light-beam moving means for moving a light-beam in the control region depending on a light-beam motion signal to guide the light-beam over the control region, different positions or positional changes of the object or several objects in the control region being associated to different reactions in the apparatus; a light sensor for detecting a reflected light-beam to generate a sensor output signal depending on the reflected light-beam; and control signal generating means formed to generate, depending on the light-beam motion signal and the sensor output signal, a control signal for the apparatus formed to cause a reaction in the apparatus which is associated to a position or a positional change in the control region defined by the light-beam motion signal and the sensor output signal; wherein the light-beam moving means and the light sensor are arranged at a side of the control region where the object may be introduced into the control region.

In accordance with a second aspect, the present invention provides a computer mouse including the above-mentioned device.

In accordance with a third aspect, the present invention provides a keyboard including the above-mentioned device.

In accordance with a fourth aspect, the present invention provides a method for controlling an apparatus depending on a position or movement of an object in a control region, having the steps of: moving a light-beam in the control region depending on a light-beam motion signal to guide the light-beam over the control region by light-beam moving means, different positions or positional changes of the object or several objects in the control region being associated to different reactions in the apparatus; detecting a reflected light-beam in a light sensor and generating a sensor output signal depending on the reflected light-beam; and generating a control signal for the apparatus in dependence on the light-beam motion signal and the sensor output signal to cause a reaction in the apparatus associated to a position or a positional change in the control region which is defined by the light-beam motion signal and the sensor output signal; wherein the light-beam moving means and the light sensor are arranged at the side where the object may be introduced into the control region.

The present invention is based on the finding of light-beam moving means placing a light-beam successively at different positions in the control region so that control signal generating means receiving a sensor output signal by a light sensor for detecting the reflected light-beam generates, based on the light-beam motion signal and the sensor output signal, a control signal for the apparatus causing a reaction therein depending on a position or positional change in the control region.

The present invention offers a way of realizing an input controller for an apparatus having few and cheap elements. Exemplarily, only a light-source changeable in its position, a light sensor and evaluation electronics are required to design keyboards of the most different configurations. These keyboards may be designed such that somebody touches a certain field on a tabletop with his/her finger and the light-beam is reflected from this field to the light sensor.

This also shows the flexibility of the present invention since, for example, the allocation of the keypads on the tabletop may be implemented only by software changes in the following evaluation electronics. At the same time, this also emphasizes the flexible usability since keyboards where only a body part or a pen must be brought to a certain point on a table can be manufactured here. Consequently, even keyboards for disabled people who are not able to press a button on an input device are conceivable.

Since the number of mechanical components in the system is reduced considerably compared to conventional systems, the input apparatus according to the present invention has the characteristic of being maintenance-free. The number of mechanical components prone to wear is reduced considerably in the device of the present invention.

Additionally, the present invention allows manufacturing input devices in a space-saving manner, since it allows utilizing a field on a table as a keyboard without special devices having to be set up on this field. A movable light-beam which is, for example, mounted on the ceiling and a light sensor mounted on the ceiling are sufficient to implement a keyboard. Additionally, the space saved on the table may then be used for drawing handwritten sketches or for filing work documents. In order to ensure a perfect operation of the device, they may be pushed aside before starting an input operation by means of the device of the present invention.

### BRIEF DESCRIPTION OF THE DRAWINGS

Preferred embodiments of the present invention will be detailed subsequently referring to the appended drawings, in which:

FIG. 1 shows an input field for moving a computer cursor;

FIG. 2 shows a numerical keyboard according to the present invention;

FIG. 3 shows an object recognition system for controlling a robot;

FIG. 4a shows light-beam moving means having a micro-mechanical scanner mirror; and

FIG. 4b is a detailed illustration of the micro-mechanical scanner mirror.

### DESCRIPTION OF PREFERRED EMBODIMENTS

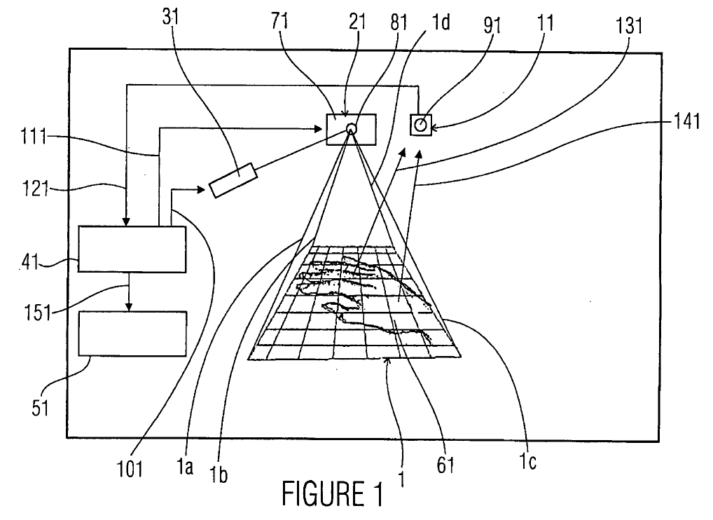

FIG. 1 illustrates a computer mouse according to the present invention. In the following description of preferred embodiments, the same elements or elements having the same effect are provided with the same reference numerals. A control field 1, a light sensor 11, light-beam moving means 21, a laser, 31, evaluating means 41 and a computer 51 are illustrated. A hand 61 moves on the control field 1 within control field limits 1a-d. The light-beam moving means 21 includes an actor 71 and a mirror 81 and is preferably embodied as a suspended micro-mechanical scanner mirror on silicon. The light sensor 11 includes, among other things, a photodiode 91.

The evaluating means 41 controls the laser 31 via a laser control signal 101 and the light-beam moving means 21 via a light-beam motion signal 111. Additionally, it receives the sensor output sensor 121 from the light sensor 11.

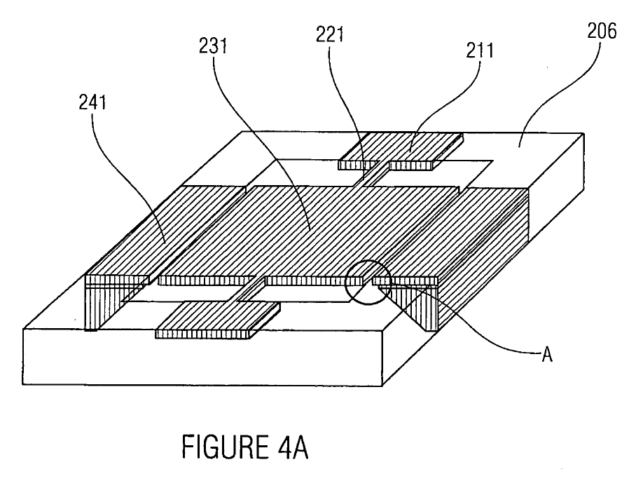

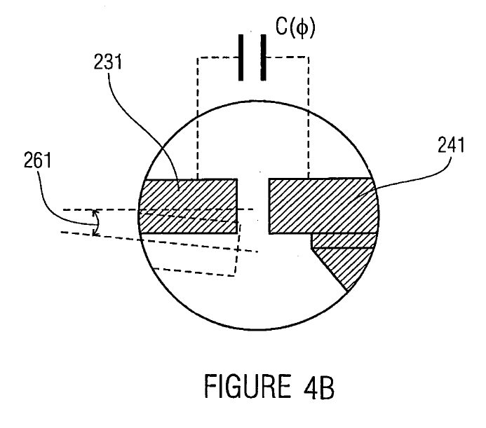

The evaluating means 41 switches on the laser 31 after the computer 51 is switched on. At the same time, it starts sending a temporally varying light-beam motion signal 111 to the light-beam moving means 21. Responsive to the temporally changing light-beam motion signal 111, the actor 71 starts changing its form such that a mirror 81 mechanically connected to the actor 71 guides a light-beam reflected at the mirror 81 through the control field 1, or the suspended micro-mechanical scanner mirror starts changing its orientation angle. This process will be described in greater detail in FIG. 4a.

While the reflected light-beam is guided through the control field 1, it is reflected at a first point in time by a middle finger of the hand 61 so that the result is a middle-finger light-beam 131, and at a second later point in time it is reflected by a point on the back of the hand so that the result is the back-of-the-hand light-beam 141.

The photodiode 91 receives the middle-finger light-beam 131 at the first point in time and the back-of-the-hand light-beam 141 at the second point in time. At the first point in time, the light sensor 11 emits, by means of the also temporally changing sensor output signal 121, information indicating reception of the middle-finger light-beam 131, and at the second point in time information indicating reception of the back-of-the-hand light-beam 141.

Since the evaluating means 41 changes the position of the light-beam in the control field 1 via the light-beam moving means 21, the evaluating means 41 can determine using the points in time when receiving information on the middle-finger light-beam 131 and information on the back-of-the-hand light-beam 141, by which position in the control field 1 a light-beam has been reflected towards the photodiode 91. Consequently, the evaluating means 41 receives locally resolved contrast values. From a comparison of the light-beam motion signal 111 and the sensor output signal, the evaluating means 41 can thus determine whether there is an object in the control field 1 and at which positions the object in the control field 1 is. Image-processing algorithms are preferably used for this in the evaluating means 41.

Since the control field 1 is passed completely by the light-beam deflected by the light-beam moving means 21 several times per second, the evaluating means 41 is able to establish positional changes of the hand 61 by means of comparing a data set determined during a second pass of the control field 1 to a data set determined during a first pass of the control field 1. By means of the comparison of the data sets of the second pass and the first pass, the evaluating means 41 is able to establish positional changes of the hand 61 in the control field 1. It generates a computer control signal 151 changing the position of a cursor on the monitor of the computer 51.

Thus, there are different ways of scanning the control field 1. On the one hand, the light-beam may sweep the control field harmonically, that means it moves uniformly from an edge point on a scanned line of control field 1 to a second edge point of the line of control field 1. On the other hand, the light-beam may also be guided to discrete points, stay there for a short moment and then jump to a next point of the control field 1 triggered by the light-beam moving means and also stay there for a short moment.

The assembly in this embodiment is able to recognize the movement of a hand or of a finger and convert it to electrical signals suitable for controlling electronic apparatuses. The actor 71 here is preferably suspended in a cardanic way and is irradiated by the laser light source 31. Control electronics in the evaluating means 41 generates a two-dimensional scan field including the control field 1 by means of electrically excited oscillation. The scan field here is preferably set up in rows or columns or also in another suitable way, such as, for example, in a resonant excitation of the deflection element or actor 71 in the form of a Lissajous figure. The scan field may then be projected to any surface, such as, for example, a table.

The reflections generated by the scan field at the incident surface are detected by means of the photo detector or light sensor 11, the sensitivity of which is preferably adjusted to the wavelength of the laser employed. The movement of a hand 61 or a finger of the hand 61 generates, by means of reflection of the laser light at the object or by a locally and temporally resolved background intensity change, intensity changes at the photo detector 11 which are converted by the evaluating electronics in the evaluating means 41 into electrical signals for controlling an electrical apparatus, such as, for example, in this embodiment the computer 51, preferably for moving a mouse indicator of a graphical interface.

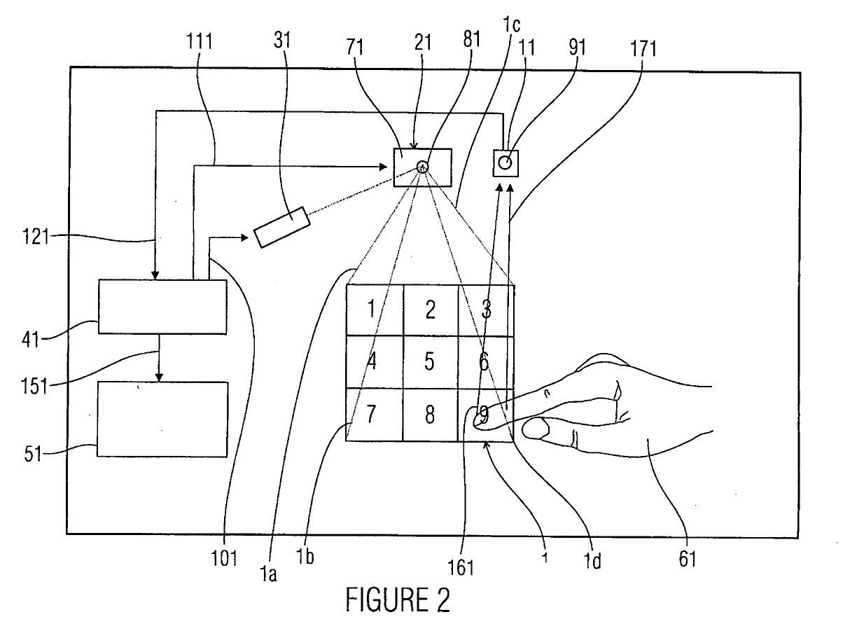

FIG. 2 discusses another embodiment of the present invention. Here, the control field 1 is embodied as a numerical keyboard on an even surface, such as, for example, a tabletop. The assembly shown in FIG. 2 corresponds to the assembly illustrated in FIG. 1, except for the difference in the configuration of the control field 1.

The different configuration of the control field 1 may be realized alone by changes in the software of evaluating means 41. This also emphasizes the great flexibility of the embodiments of the present invention.

An index finger of a hand 61 of a user here has been placed in the control field 1 so that a fingertip covers a region of the control field 1 associated to the number 9. A light-beam guided over the control field 1 by the, light-beam moving means is reflected both by an index fingernail, so that the result is an index-fingernail light-beam 161, and also by an index finger knuckle, so that the result is an index-finger-knuckle light-beam 171. The index-fingernail light-beam 161 and the index-finger-knuckle light-beam 171 are detected by the light sensor 11 in temporal sequence, whereupon it sends information to the evaluating means 41 via the sensor output signal 121. This information can be compared to the temporal course of the light-beam motion signal 111 in the evaluating means 41 for example by means of a processor, which is how the evaluating means 41 comes to the conclusion that a fingertip covers the number field of the number 9.

The evaluating means 41 communicates to the computer 51 via the computer control signal 151 that the user has pressed the number 9 by the hand 61 and causes a corresponding operation on the PC. This operation may, for example, be inserting a 9 into a text document.

The embodiment is able to recognize the movement of a hand or a finger and to convert it to electrical signal suitable for controlling electronic apparatuses. In this embodiment, however, a virtual numerical key assembly is additionally projected to any surface. The laser beam moving means 21 is again preferably suspended in a cardanic way and irradiated by the laser 31. Here, too, the laser beam moving means 21 is formed by means of a micro-mechanical actor 71 and a reflecting region on the micro-mechanical actor 71. The micro-mechanical actor is controlled by an electrically excited oscillation by the evaluating means 41 so that the result is a two-dimensional scan field, wherein the scan field may be formed in rows and columns or in any other suitable form, such as, for example, when using a resonant assembly of the deflection element, in the form of a Lissajous figure. Any pattern, such as, for example, a virtual numerical keyboard assembly, is projected onto any surface, such as, for example, a table, by pulsing the light source 31.

The reflections generated by the scan field at the incident surface are detected by means of the photo detector 11, the sensitivity of which is preferably adjusted to the wavelength of the laser employed. Pressing a key by a finger, i.e. moving the finger in a certain region of the scan field 1 on the projected numerical keyboard, generates, by means of reflection of the laser light at the object or by locally and temporally resolved background intensity changes, intensity changes at the photo detector 11 which are converted by the evaluating electronics in the evaluating means 41 into electrical signals for controlling an electrical apparatus, such as, for example, the computer 51, or for inputting data, such as, for example, an automatic teller machine.

By means of a suitable run-time measurement in the above embodiments shown in FIGS. 1 and 2, conclusions can be drawn to the position or positional change of the hand 61 and the three-dimensional assembly thereof relative to the control field 1. Here, a run-time within which the light-beams have passed the path from the laser 31 to the photodiode 91 is determined.

When the light-beam is guided over the control field 1 in a way such that only the tilt of the mirror 81 relative to the control field 1 is changed, the run-time of the light-beam from the laser 31 to the mirror 81 is constant. The run-time differences then result by different path lengths from the mirror 81 to the object 61 where the light-beam is reflected, and from there to the photodiode 91. Using the run-time of the light-beam from the laser 31 to the photodiode 91, conclusions may be drawn to the three-dimensional arrangement of the hand 61 relative to the control field 1.

The run-time of the light-beam may be determined, for example, by the evaluating means 41 controlling the modulation of the light-beam of the laser 31 via the laser control signal 101. An intensity of the light-beam here fluctuates periodically. By comparing a periodical course of the modulated light-beam of the laser to temporal fluctuations of the sensor output signal, the evaluating means 41 determines the run-time of the light-beam and can thus determine the three-dimensional form of the object in the control field.

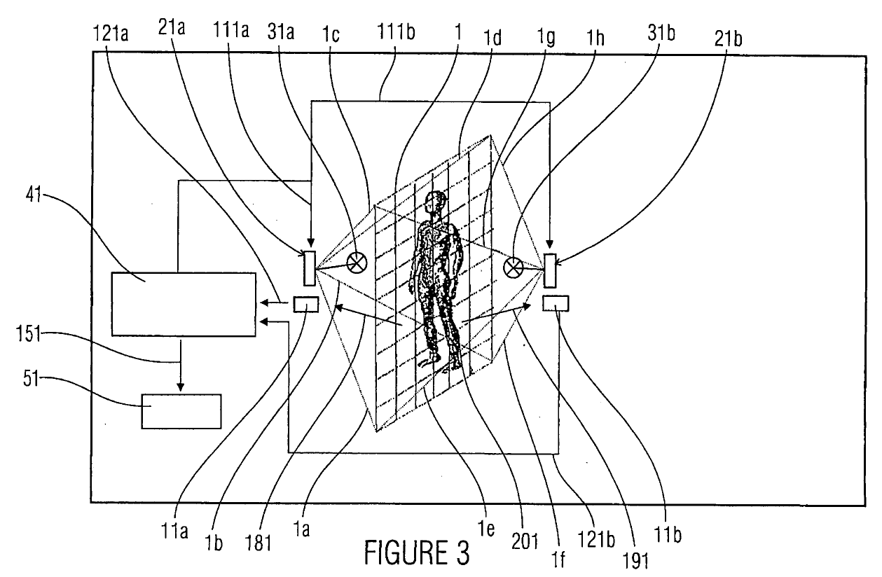

FIG. 3 discusses a three-dimensional object recognition system for controlling a complex robot. The difference to the embodiment shown in FIG. 1 is that the light-beam moving means 21 is formed as a first light-beam moving means 21a and a second light-beam moving means 21b, the laser 31 is formed as a first laser 31a and a second laser 31b and the light sensor 11 is formed as a first light sensor 11a and a second light sensor 11b. A human body 201 is arranged in the control field 1.

The first light-beam moving means 21a is controlled via a first light-beam motion signal 111a, the second light-beam moving means 21b is controlled via a second light-beam motion signal 111b. At the human body 201, light-beams moved by the light-beam moving means 21a, 21b are reflected so that, for example, the reflected light-beams 181, 191 result. The first light sensor 11a generates a first sensor output signal 121a, whereas the second light sensor 11b generates a second sensor output signal 121b.

In analogy to the embodiment discussed in FIG. 1, the embodiment in FIG. 3 generates a two-dimensional image of the control field 1 from a comparison of the first sensor output signal 121a to the first light-beam motion signal 111a. This two-dimensional image of the control field 1 is, however, additionally determined by means of a comparison of the second light-beam motion signal 111b and the sensor output signal 121b from the side where the light-beam moving means 21b is arranged. The evaluating means 41 thus comprises two nearly synchronously recorded 2D images of the control field 1, these two-dimensional images being recorded from two different sides.

By a suitable superposition of the respective two-dimensional images of the control field 1, a three-dimensional image of outlines of the human body 201 in the control field 1 can be determined. From the three-dimensional image of the control field 1 determined in turn, a computer control signal 151 controlling a computer 51 for controlling a robot may be generated.

The light-beam moving means 21a and 21b include two cardanically suspended micro-mechanical actors, the optical axes of which are arranged in an angle of 180° in the same plane, which are irradiated by the laser light sources 31a, 31b and can generate a three-dimensional scan field by an electrically excited oscillation from a control electronics in the evaluating means 41. The three-dimensional scan field here is formed by superimposing onto one another at least two two-dimensional scan fields. The two two-dimensional scan fields here may be formed in rows and columns or in any other suitable way, such as, for example, when using a resonant excitation of the deflecting element in the form of a Lissajous figure. For increasing the system resolution, the three-dimensional scan field may additionally be generated by three cardanically suspended micro-mechanical actors, the optical axes of which are arranged in an angle of 120° in the same plane.

The reflections generated by the scan field at the incident surface are detected by the photo detectors 11a, 11b, the sensitivity of which preferably corresponds to the wavelength of the laser employed. The movements of a body or human in the scan field generate, by reflections of the laser light at the object or by locally and temporally resolved background intensity changes, intensity changes at the photo detectors 11a, 11b which are converted into electrical signals for controlling a complex robot by the evaluating electronics in the evaluating means 41.

FIG. 4a discusses an embodiment of the light-beam moving means 21. A substrate 206, two anchors 211, two torsion springs 221, a mirror plate 231, two driving electrodes 241 and a buried oxide 251 are illustrated. The anchors 211 are deposited onto the silicon substrate 206 and mechanically connected to the mirror plate 231 via the torsion springs 221.

The driving electrodes 241 are electrically insulated from the mirror plate 231, and their vertical sides each form a capacitor with it. The capacity of the respective capacitors thus depends on the deflection of the mirror plate 231. The sector A shows the arrangement of the mirror plate 231 and the driving electrode 241 in greater detail.

In FIG. 4b, the transition between the driving electrode 241 and the mirror plate 231 is discussed in greater detail. Here, it can be seen that the capacity of the capacitor formed of the two elements decreases with an increasing torsion angle 261. With an increasing torsion angle, the overlapping plate area of the capacitor formed of the mirror plate 231 and the driving electrode 241 decreases.

An oscillation buildup of the mirror place 231 results from asymmetries, due to manufacturing, of the transitions between the driving electrodes 241 and the mirror plate 231. The torsion springs here generate a torque counteracting the deflection or tilt of the mirror plate 231. The charges present on the capacitor plates having different signs result in a mutual attraction of the driving electrode 241 and the mirror plate 231 and thus also in a torque counteracting the tilt of the mirror plate 231. The voltage between the mirror plate 231 and the driving electrodes 241 here is selected such that it only occurs, when oscillating, in the period of time between the reverse point where the mirror plate exhibits its maximum deflection and the zero crossing, the point in time where the maximum capacity of the capacitor formed of the mirror plate 231 and the driving electrode 241 is applied. Consequently, it is only in this period of time that energy is supplied to the oscillating system. If the voltage was also applied in the period of time between the zero crossing and the reverse point, the electrostatic attraction force between the capacitor plates of the driving electrode 241 and the mirror plate 231 would result in a dampening of the oscillation.

The above embodiments have shown that the input or control apparatus for electronic apparatuses and systems according to the present invention makes use of the cooperation of micro-mechanical actors and opto-electronic sensors, wherein micro-mechanical actors here are elements designed for the continual or quasi-static deflection of light, beam positioning, switching light between different receivers, determining forces, accelerations, movements or the position, such as, for example, tilting or deflection, or for other applications. In addition, the above embodiments use opto-electronic sensors designed for a measurement-technological detection of optical signals, the conversion thereof to a representative electrical quantity and quantization thereof. In the above embodiments of the present invention, the cooperation of micro-mechanical actors and opto-electronic sensors of this kind results in determining the position and/or the movement of an object which is arranged in a scan field generated by a micro-mechanical element and, in the end, controlling electronic apparatuses and systems using the data obtained. The arrangement of such a system allows manufacturing input devices, compared to existing solutions operating using recording images of the human body and evaluating them by high-cost cameras, in a cheap, highly integrated, highly precise and wear-free way.

A method and an arrangement for implementing the method by means of which the user of an electronic apparatus may control it in a simple, intuitive, direct way without tactile input devices are discussed in the above embodiments. The method and the arrangement here should implement the actions desired by the operator with high precision and, if possible, in real time. The arrangement is to detect the movement and/or the position of an object or a body part and convert same into electronic signals suitable for controlling electronic apparatuses.

This may be realized by one or several cardanically suspended micro-mechanical actors generating a two-dimensional scan field or two superimposed two-dimensional scan fields, a three-dimensional scan field by deflecting a laser beam or several laser beams. Here, the apparatus operates according to the principle of a scanner which is able to obtain brightness information from points or point clouds in the one-, two- or three-dimensional space. An object or a body part arranged in the scan field causes reflections and absorptions from the laser beam deflected by the mirror and thus generates intensity changes relative to one or several fixed points where there are preferably one or two optical sensor elements. For detecting intensity changes and the interpretation thereof with regard to the control of electronic apparatuses, a 2D scanner or two-dimensional scanner and a receiver diode are required. In order to extend the user interface to the three-dimensional space, two 2D scanners, and in case switching-off is not taken into consideration, one 2D scanner is sufficient, and a CCD sensor or charged-coupled device sensor are required. This allows detecting the space depth by means of triangulation. When the run-time measurement method is used, two 2D scanners and a photodiode are sufficient, and when switching-off is not to be considered, even one 2D scanner is sufficient. Thus, the deflected laser beams must be pulsed in order for the light run-time between scanner mirror, object and receiving diode to be determined, from which in the end the distance to the object results.

These intensity changes are then converted into an electrical signal by the optical sensor element or several optical sensor elements. Departing from the known deflection angle of the micro-mechanical actor or actors and the intensity changes detected by means of the optical sensor elements, the depth measurement and suitable evaluating electronics, it is possible to determine the position and/or the movement of an object or a body part in the scan field. The advantage of the method according to the above embodiments is that detection and projection unit may be united to one element, the micro-mechanical actor. This means that the scanner is able to project the graphical user interface to different bases and at the same time scan the object. Another advantage is the usage of only one CCD sensor or charged-coupled device sensor in 3D applications by means of triangulation or receiving diode in a run-time measurement.

In the above embodiments, assemblies for controlling the electronic apparatuses by an opto-electronic motion detection of a hand or a finger in the two-dimensional space, or in the three-dimensional space an assembly for recognizing the movement of an object for controlling a complex robot are illustrated. The movement of a hand or a finger can thus directly control an electronic apparatus or indirectly via the simultaneous projection of a virtual numerical key. Furthermore, a complex robot may be controlled via a so-called three-dimensional scanning of a body.

In the above embodiments, systems for optically detecting movements and positional detections of the human body or of body parts for controlling the electronic or electronically controllable devices by the optical detection on a micro-mechanical deflection unit defining the field in question for detection and converting the radiation reflected from the field to an electrical signal by means of one or several detectors have been implemented.

In the above embodiments, information on the deflection unit or the light-beam moving means is additionally projected into the field. Thus, a virtual operator interface, such as, for example, a keyboard, may be projected into the field, or the outlines of a virtual mouse pad may be projected into the field via the light-beam movement means 21. Furthermore, an additionally generated virtual operator interface of a graphical user interface of an electronic apparatus may be superimposed on the control field via the light-beam moving means 21 to obtain the function of a touch screen.

In the above embodiments, the system may, however, also be formed such that it is able to recognize genetic features, such as, for example, a fingerprint, to identify the operator in this way. Additionally, the system in the above embodiments may be implemented such that it is able to detect movements or positions in the one-dimensional space or detect positions, sites and movements in the two-dimensional space. Additionally, the system explained in the above embodiments may also detect movements in the three-dimensional space. The system presented in the above embodiments is able to correspond with IBM-compatible PCs, to be addressed or to be read out by them. The communication of the system with an external apparatus here may preferably take place via a typical PC interface, such as, for example, an USB interface, a PS/2 interface or an RS232 interface.

The laser employed in the above embodiments may in an alternative form be formed as any light source generating light which is deflected by the light-beam moving means 21. Even the photodiode 91 may be replaced by any light-sensitive sensor generating an electrical signal responsive to an incident light-beam.

As an alternative to the actor 21, the position of the mirror 81 may also be implemented by other means converting an electrical signal into a mechanical positional change, such as, for example, an electric motor. The body parts mentioned in the above embodiments, such as, for example, the hand (61) or the human body (201) of FIG. 3, may alternatively be implemented by any other objects or, particularly, pens allowing a precise input of information.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A device for controlling an apparatus depending on a position or movement of an object in a control region, comprising:
a light-beam mover for moving a light-beam in the control region depending on a light-beam motion signal to guide the light-beam over the control region, different positions or positional changes of the object or several objects in the control region being associated to different reactions in the apparatus;
a light sensor for detecting a reflected light-beam to generate a sensor output signal depending on the reflected light-beam; and
a control signal generator formed to generate, depending on the light-beam motion signal and the sensor output signal, a control signal for the apparatus formed to cause a reaction in the apparatus associated to a position or positional change in the control region which is defined by the light-beam motion signal and the sensor output signal;
wherein the light-beam mover and the light sensor are arranged at a side of the control region where the object may be introduced into the control region.

2. The device for controlling an apparatus according to claim 1, wherein the control signal generator is formed to compare a temporal course of the sensor output signal to a temporal course of the light-beam motion signal and cause a reaction in the apparatus from this.

3. The device for controlling an apparatus according to claim 1, wherein the light-beam mover is pivotally arranged at a fixed location opposite the control region.

4. The device for controlling an apparatus according to claim 3, wherein the light sensor is arranged at a fixed location opposite the control region.

5. The device for controlling an apparatus according to claim 3, comprising:
another light-beam mover which is pivotally arranged at a fixed location opposite the control region and is spaced apart from the light-beam mover, for moving another light-beam in the control region depending on another light-beam motion signal to place the other light-beam successively at different positions in the control region;
another light sensor-for detecting another reflected light-beam to generate another sensor output signal depending on the other reflected light-beam; and
a control signal generator which is formed
to generate a first two-dimensional image of the control region depending on the light-beam motion signal and the sensor output signal and generate a second two-dimensional image of the control region depending on the other light-beam motion signal and the other sensor output signal;
to generate a three-dimensional image which is reduced in shadowing from a superposition of the first and the second two-dimensional images onto each other; and
to generate, from the three-dimensional image, a control signal for the apparatus formed to cause a reaction in the apparatus which is associated to a three-dimensional position or positional change of the object in the control region which is defined by the superposition of the first and the second two-dimensional images onto each other.

6. The device for controlling an apparatus according to claim 5, wherein the other light sensor is arranged at a fixed location opposite the control region.

7. The device for controlling an apparatus according to claim 5, wherein the other light-beam mover is arranged at a side of the control region facing away from the light-beam mover.

8. The device for controlling an apparatus according to claim 1, wherein the light-beam mover includes a reflector, the position or orientation of which is controllable by an actor formed to be controlled by the light-beam motion signal such that the light-beam may be placed successively at different positions in the control region.

9. The device for controlling an apparatus according to claim 8, wherein the light-beam motion signal includes an oscillating signal.

10. The device for controlling an apparatus according to claim 1, wherein the control signal generator performs a measurement of a run-time required by the light-beam to move from the light-beam mover to the light sensor.

11. The device for controlling an apparatus according to claim 1, wherein the light-beam mover and the light sensor are integrated in one element.

12. The device for controlling an apparatus according to claim 1, wherein the positions in the control region are arranged in the form of rows or columns.

13. A computer mouse including a device for controlling an apparatus depending on a position or movement of an object in a control region comprising a light-beam mover for moving a light-beam in the control region depending on a light-beam motion signal to guide the light-beam over the control region, different positions or positional changes of the object or several objects in the control region being associated to different reactions in the apparatus; a light sensor for detecting a reflected light-beam to generate a sensor output signal depending on the reflected light-beam; and a control signal generator formed to generate, depending on the light-beam motion signal and the sensor output signal, a control signal for the apparatus formed to cause a reaction in the apparatus associated to a position or positional change in the control region which is defined by the light-beam motion signal and the sensor output signal; wherein the light-beam mover and the light sensor are arranged at a side of the control region where the object may be introduced into the control region.

14. A keyboard including a device for controlling an apparatus depending on a position or movement of an object in a control region comprising a light-beam mover for moving a light-beam in the control region depending on a light-beam motion signal to guide the light-beam over the control region, different positions or positional changes of the object or several objects in the control region being associated to different reactions in the apparatus; a light sensor for detecting a reflected light-beam to generate a sensor output signal depending on the reflected light-beam; and a control signal generator formed to generate, depending on the light-beam motion signal and the sensor output signal, a control signal for the apparatus formed to cause a reaction in the apparatus associated to a position or positional change in the control region which is defined by the light-beam motion signal and the sensor output signal; wherein the light-beam mover and the light sensor are arranged at a side of the control region where the object may be introduced into the control region.

15. A method for controlling an apparatus depending on a position or movement of an object in a control region, comprising the steps of:
moving a light-beam in the control region depending on a light-beam motion signal to guide the light-beam over the control region by a light-beam mover, different positions or positional changes of the object or several objects in the control region being associated to different reactions in the apparatus;
detecting a reflected light-beam in a light sensor and generating a sensor output signal depending on the reflected light-beam; and
generating a control signal for the apparatus in dependence on the light-beam motion signal and the sensor output signal to cause a reaction in the apparatus associated to a position or a positional change in the control region which is defined by the light-beam motion signal and the sensor output signal;
wherein the light-beam mover and the light sensor are arranged at the side where the object may be introduced into the control region.
